(19) United States
(12) Patent Application Publication
(10) Pub. No.: US 2016/0328146 A1
(43) Pub. Date: Nov. 10, 2016

(54) BATCH PROCESSING OPERATION METHOD AND DEVICE

(71) Applicant: YULONG COMPUTER TELECOMMUNICATION SCIENTIFIC (SHENZHEN) CO., LTD., Shenzhen (CN)

(72) Inventor: XUE-YING JING, Shenzhen (CN)

(21) Appl. No.: 15/216,714

(22) Filed: Jul. 22, 2016

Related U.S. Application Data
(63) Continuation-in-part of application No. PCT/CN2014/071375, filed on Jan. 24, 2014.

(51) Int. Cl. G06F 3/0488; G06F 3/0481; G06F 3/0482; G06F 3/041

(52) U.S. Cl. CPC G06F 3/04883; G06F 3/041; G06F 3/04817; G06F 3/0482; G06F 2203/04104; G06F 2203/04808

(57) ABSTRACT

A batch processing operation method and device are provided. The method includes: identifying touch points generated simultaneously on a terminal screen; determining whether positions of at least two of the touch points are within an area of a grid path, the grid path being formed by the spaces among operation objects on the terminal screen; forming a batch processing operation object area on the terminal screen according to the at least two of the touch points whose positions are within an area of the grid path; and executing a predetermined operation on one or more operation objects in the batch processing operation object area. The present disclosure utilizes space areas among operation objects, and selects a batch processing operation object area quickly according to user operations, and executes batch processing operations on operation objects in the batch processing operation object area. Thus, efficiency can be improved.

This application is a continuation-in-part of International Application No. PCT/CN2014/071375, filed on Jan. 24, 2014.

### FIELD

The embodiments of the present disclosure relate to communication technology, and specifically, relate to a batch processing operation method and a batch processing operation device.

### BACKGROUND

Nowadays, operations on application icons can include hiding, deleting, uninstalling, and so on, and are commonly executed in the following two ways.

Firstly, a certain trigger means (holding down the application icons for a period) is used to execute the operations on the application icons one by one. The operations on each of the application icons can be achieved by a selection step and a confirmation step. When operations on a plurality of application icons are needed, it is time consuming due to complex steps of batch processing operations on the application icons.

Secondly, a particular checking interface needs to be opened to check the application icons one by one. After a checking step on the application icons is executed, a further confirmation step is needed to achieve batch processing operations on the application icons. In some cases, application icons, on which a user wants to execute batch processing operations, may be listed on a same page (for example, a user wants to uninstall application of a network operator) of a graphical user interface (GUI). However, the application icons are not listed in the same page of the checking interface. It is troublesome to check all of the application icons in the checking interface.

Terminal screen sizes become larger and larger. Thus, spaces among operation objects, such as the application icons, on the terminal screen become larger than before. However, the existence of large spaces on the terminal screen is not utilized to control a terminal in prior art.

Executing batch processing operations on the operation objects using the spaces among the operation objects is problematic.

### SUMMARY OF THE INVENTION

To solve the above problem, the present disclosure provides a new way of batch processing operations, which can execute batch processing operations on operation objects conveniently and quickly, using spaces among the operation objects.

Therefore, according to one aspect of the present disclosure, a batch processing operation method is provided. The batch processing operation method includes: identifying simultaneous touch points on a terminal screen; determining whether positions of at least two of the touch points are within an area of a grid path, the grid path being formed by spaces among operation objects on the terminal screen; forming a batch processing operation object area on the terminal screen according to the at least two of the touch points which have positions within an area of the grid path; and executing a predetermined operation on one or more of the operation objects in the batch processing operation object area.

Data files, such as application icons, documents, pictures, and so on, can be displayed on the terminal screen. When a size of the terminal screen becomes larger, spaces among the data become larger correspondingly. The background areas outside the data files can form an area of a grid path. Taking advantage of the area of the grid path, the present embodiment checks whether at least two of the touch points are within the area of the grid path. When at least two of the touch points are within the area of the grid path, a batch processing operation mode provided in the present embodiment can be triggered. According to positions of the touch points that are eligible, a batch processing operation object area can be formed on a current interface of the terminal screen. The batch processing operation object area involves a plurality of operation objects. When a user selects an operation, such as a deletion operation, all the operation object involved in the batch processing operation object area are deleted. There is no need to select operation objects one by one, and also no need to enter a particular batch processing operation interface. Efficiency can be improved, and the spaces among the operation objects can be fully utilized. A quick and convenient usage is provided to the spaces.

In the above embodiment, preferably, forming a batch processing operation object area on the terminal screen according to the at least two of the touch points which have positions within an area of the grid path includes: taking the touch points which are within the area of the grid path as vertexes of the batch processing operation object area; generating lines with the touch points as starting points along the grid path; and forming a closed area by intersecting the generated lines, wherein the closed area is the batch processing operation object area.

When forming the batch processing operation object area, the grid path needs to be considered. The touch points are taken as vertexes of the batch processing operation object area, and an area formed by lines which start from the touch points and along the grid path is taken as the batch processing operation object area. In a preferable embodiment, two of the touch points which are located on different positions of the area of the grid path can generate a rectangular area, which is determined to be the batch processing operation object area.

Any of the above embodiments, preferably, includes: generating an entirety of the operation objects by superposing the operation objects in the batch processing operation object areas, after forming the batch processing operation object area, for a single operation by a user.

For further facilitating the operations for a user, when a batch processing operation object area is formed and selected, the operation objects in the batch processing operation object can be superposed to generate an entirety of the operation objects. The user can execute operations on the entirety of the operation objects, such as moving. Thus, there is no need to select the operation objects again.

Any of the above embodiments, preferably, includes: displaying at least one operation option after moving the entirety of the operation objects to a designated area of the terminal screen; and executing a batch processing operation corresponding to one operation option on the entirety of the operation objects when the entirety of the operation objects is moved to the operation option.

When the entirety of the operation objects is moved to a designated area, such as an edge area of the terminal screen, at least one operation option is displayed on the edge area. The at least one operation option can be deletion, hiding, creating a new folder, encryption, or other operations. When the entirety of the operation objects is moved to one operation option, and stays for 2 seconds, it is determined that that particular operation option is selected, and a batch processing operation corresponding to the selected operation option is executed on the entirety of the operation objects. The batch processing operation to the entirety of the operation objects is quick and convenient. The batch processing operation can be achieved without repeated operations by a user.

Any of the above embodiments, preferably, includes: prompting at least one operation option after generating the entirety of the operation objects; and executing a batch processing operation corresponding to a selected operation option on the entirety of the operation objects.

Besides moving the entirety of entirety of the operation objects to a designated area, another embodiment can display the operation options when the entirety of the operation objects is generated. The user can select one operation option. After the operation option is selected, a batch processing operation corresponding to the selected operation option can be executed on the entirety of the operation objects.

Any of the above embodiments, preferably, includes: determining whether a trigger means applied to the touch points matches a predetermined trigger means; executing a batch processing operation mode when the trigger means applied to the touch points matches the predetermined trigger means, and marking the batch processing operation object area and the touch points.

Due to there are too many operation gestures to terminals, for distinguishing between a multitude of possible operation gestures, a particular trigger means of the touch points can be predetermined. The predetermined trigger means enables the terminals to execute the batch processing operation mode. The predetermined trigger means can include a plurality of touch points being long pressed on the terminal screen, or two touch points being pinched to zoom on the terminal screen, or one of two touch points being fixed and the other one of the two points sliding toward the fixed touch point. After executing the batch processing operation mode, the batch processing operation object area and the touch points can be marked using a particular showing style, for the user to distinguish the batch processing operation object area. The particular showing style can be floating display of the batch processing operation object area, in which the touch points are represented by dots.

Any of the above embodiments, preferably, includes: executing the predetermined operation, upon the condition that an area adjusting operation is not detected in a predetermined time period after marking the batch processing operation object area and the touch points; and generating a new batch processing operation object area according to an adjusted position of one or more of the touch points, upon the condition that an area adjusting operation is detected in the predetermined time period.

It may be understood that, the batch processing operation object area may be formed improperly. The present embodiment can adjust the batch processing operation object area flexibly. A predetermined time period, such as 3 seconds can be set. During the predetermined time period, it is detected whether a user executes an area adjusting operation. When the user executes an area adjusting operation, the batch processing operation object area is adjusted. Otherwise, when the user does not execute the area adjusting operation, the batch processing operation object area is not adjusted.

Assuming that the batch processing operation object area is formed according to two touch points, a position of one of the two touch points can be adjusted to stretch or shrink the batch processing operation object area, when adjusting the batch processing operation object area.

In any of the above embodiments, preferably, when the operation objects are application icons, the predetermined operations include at least one of the following: deleting the application icons, hiding the application icons, uninstalling the application icons, encrypting the application icons or applications corresponding the application icons, backing up data of the applications, moving the application icons into a designated folder, classifying the application icons, and moving the application icons into different folders automatically according to classifications.

According to another aspect of the present disclosure, a batch processing operation device is provided. The batch processing operation device includes: an identification unit, which identifies simultaneous touch points generated on a terminal screen; a determination unit, which determines whether positions of at least two of the touch points are within an area of a grid path, the grid path being formed by spaces among operation objects on the terminal screen; an area forming unit, which forms a batch processing operation object area on the terminal screen according to the at least two of the touch points which have positions within an area of the grid path; and an execution unit, which executes a predetermined operation on one or more of the operation objects in the batch processing operation object area.

Data files, such as application icons, documents, pictures, and so on, can be displayed on the terminal screen. When a size of the terminal screen becomes larger, spaces among the data become larger correspondingly. The background areas outside the data files can form an area of a grid path. Taking advantage of the area of the grid path, the present embodiment checks whether at least two of the touch points are within the area of the grid path. When at least two of the touch points are within the area of the grid path, a batch processing operation mode provided in the present embodiment can be triggered. According to positions of the touch points that are eligible, a batch processing operation object area can be formed on a current interface of the terminal screen. The batch processing operation object area involves a plurality of operation objects. When a user selects an operation, such as a deletion operation, all the operation object involved in the batch processing operation object area are deleted. There is no need to select operation objects one by one, and also no need to enter a particular batch processing operation interface. Efficiency can be improved, and the spaces among the operation objects can be fully utilized. A quick and convenient usage is provided to the spaces.

In the above embodiment, preferably, the area forming unit includes: a touch points locating unit, which takes the touch points which are within the area of the grid path as vertexes of the batch processing operation object area, and generates lines with the touch points as starting points along the grid path; and an area division unit, which forms a closed area by intersecting the generated lines, wherein the closed area is the batch processing operation object area.

When forming the batch processing operation object area, the grid path needs to be considered. The touch points are taken as vertexes of the batch processing operation object area, and an area formed by lines which start from the touch points and along the grid path is taken as the batch processing operation object area. In a preferable embodiment, two of the touch points which are located on different positions of the area of the grid path can generate a rectangular area, which is determined to be the batch processing operation object area.

Any of the above embodiments, preferably, includes: a superposition unit, which generate an entirety of the operation objects by superposing the operation objects in the batch processing operation object areas, after forming the batch processing operation object area, for a single operation by a user.

For further facilitating the operations for a user, when a batch processing operation object area is formed and selected, the operation objects in the batch processing operation object can be superposed to generate an entirety of the operation objects. The user can execute operations on the entirety of the operation objects, such as moving. Thus, there is no need to select the operation objects again.

Any of the above embodiments, preferably, includes: a first prompt unit, which displays at least one operation option after moving the entirety of the operation objects to a designated area of the terminal screen; and an operation object selection unit, which executes a batch processing operation corresponding to one operation option on the entirety of the operation objects when the entirety of the operation objects is moved to the operation option.

When the entirety of the operation objects is moved to a designated area, such as an edge area of the terminal screen, at least one operation option is displayed on the edge area. The at least one operation option can be deletion, hiding, creating a new folder, encryption, or other operations. When the entirety of the operation objects is moved to one operation option, and stays for 2 seconds, it is determined that that particular operation option is selected, and a batch processing operation corresponding to the selected operation option is executed on the entirety of the operation objects. The batch processing operation to the entirety of the operation objects is quick and convenient. The batch processing operation can be achieved without repeated operations by a user.

Any of the above embodiments, preferably, includes: a second prompt unit, which prompts at least one operation option after generating the entirety of the operation objects; and executes a batch processing operation corresponding to a selected operation option on the entirety of the operation objects.

Besides moving the entirety of entirety of the operation objects to a designated area, another embodiment can display the operation options when the entirety of the operation objects is generated. The user can select one operation option. After the operation option is selected, a batch processing operation corresponding to the selected operation option can be executed on the entirety of the operation objects.

In any of the above embodiments, preferably, the determination unit further determines whether a trigger means applied to the touch points matches a predetermined trigger means; and the batch processing operation device further includes: a mark unit, which executes a batch processing operation mode when the trigger means applied to the touch points matches the predetermined trigger means, and marks the batch processing operation object area and the touch points.

Due to there are too many operation gestures to terminals, for distinguishing between a multitude of possible operation gestures, a particular trigger means of the touch points can be predetermined. The predetermined trigger means enables the terminals to execute the batch processing operation mode. The predetermined trigger means can include a plurality of touch points being long pressed on the terminal screen, or two touch points being pinched to zoom on the terminal screen, or one of two touch points being fixed and the other one of the two points sliding toward the fixed touch point. After executing the batch processing operation mode, the batch processing operation object area and the touch points can be marked using a particular showing style, for the user to distinguish the batch processing operation object area. The particular showing style can be floating display of the batch processing operation object area, in which the touch points are represented by dots.

Any of the above embodiments, preferably, includes: a detection unit, which executes the predetermined operation, upon the condition that an area adjusting operation is not detected in a predetermined time period after marking the batch processing operation object area and the touch points; and an area adjusting unit, which generates a new batch processing operation object area according to an adjusted position of one or more of the touch points, upon the condition that an area adjusting operation is detected in the predetermined time period.

It may be understood that, the batch processing operation object area may be formed improperly. The present embodiment can adjust the batch processing operation object area flexibly. A predetermined time period, such as 3 seconds can be set. During the predetermined time period, it is detected whether a user executes an area adjusting operation. When the user executes an area adjusting operation, the batch processing operation object area is adjusted. Otherwise, when the user does not execute the area adjusting operation, the batch processing operation object area is not adjusted.

Assuming that the batch processing operation object area is formed according to two touch points, a position of one of the two touch points can be adjusted to stretch or shrink the batch processing operation object area, when adjusting the batch processing operation object area.

In any of the above embodiments, preferably, when the operation objects are application icons, the predetermined operations include at least one of the following: deleting the application icons, hiding the application icons, uninstalling the application icons, encrypting the application icons or applications corresponding the application icons, backing up data of the applications, moving the application icons into a designated folder, classifying the application icons, and moving the application icons into different folders automatically according to classifications.

According to another aspect of the present disclosure, a program product stored in a non-transitory computer readable medium is provided. The program product is used to execute batch processing operation, and includes instructions executable by a computer system to perform the following steps: identifying simultaneous touch points on a terminal screen; determining whether positions of at least two of the touch points are within an area of a grid path, the grid path being formed by spaces among operation objects on the terminal screen; forming a batch processing operation object area on the terminal screen according to the at least two of the touch points which have positions within an area of the grid path; and executing a predetermined operation on one or more of the operation objects in the batch processing operation object area.

According to another aspect of the present disclosure, a non-transitory computer readable medium is also provided. The non-transitory computer readable medium stores a program product which is used to execute batch processing operation and includes instructions executable by a computer system to perform the following steps: identifying simultaneous touch points on a terminal screen; determining whether positions of at least two of the touch points are within an area of a grid path, the grid path being formed by spaces among operation objects on the terminal screen; forming a batch processing operation object area on the terminal screen according to the at least two of the touch points which have positions within an area of the grid path; and executing a predetermined operation on one or more of the operation objects in the batch processing operation object area.

According to another aspect of the present disclosure, a program readable by a machine is also provided. When executed by the machine, the program can cause the machine to perform a batch processing operation method of any of the above mentioned embodiments.

According to another aspect of the present disclosure, a storage medium which stores a program readable by a machine is also provided. When executing the program, the machine can perform a batch processing operation method of any of the above mentioned embodiments.

### BRIEF DESCRIPTION OF THE DRAWINGS

FIG. 1 is a schematic diagram of one embodiment of a grid path on a terminal screen according to the present disclosure.

FIG. 2 is a schematic flowchart of one embodiment of a batch processing operation method according to the present disclosure.

FIG. 3 is a schematic diagram of one embodiment of a batch processing operation object area formed according to touch points according to the present disclosure.

FIG. 4 is a schematic diagram of one embodiment of an entity of operation objects according to the present disclosure.

FIG. 5 is a schematic diagram of one embodiment of moving an entity of operation objects and selecting an operation option according to the present disclosure.

FIG. 6 is a schematic diagram of one embodiment of prompting selective operation options after generating an entirety of operation objects, according to the present disclosure.

FIG. 7 is a schematic diagram of one embodiment of an adjustment of a formed batch processing operation object area according to the present disclosure.

FIG. 8 is a schematic block structure of one embodiment of a batch processing operation device according to the present disclosure.

### DETAILED DESCRIPTION

For simplicity and clarity of illustration, where appropriate, the above drawings illustrate embodiments of this disclosure. It may be appreciated that different embodiments and elements in the different embodiments of the present disclosure can be combined or may be not combined.

The embodiments described herein are for better understanding of the present disclosure, other embodiments can also be practiced. The description is not to be considered as limiting the scope of the embodiments described herein.

First of all, some phrases are explained as follows:

Space areas: background spaces between operation objects (such as application icons, documents, folders, and so on) on a display interface.

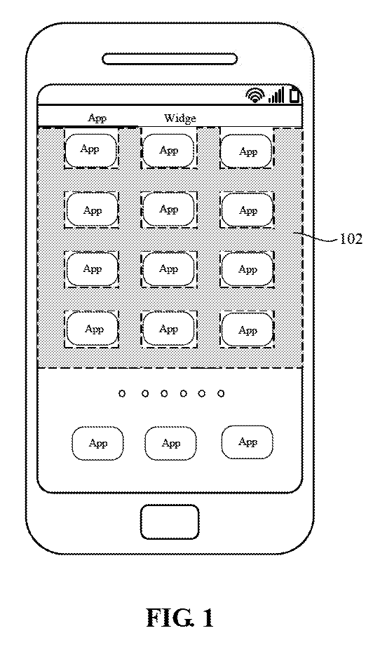

Grid path: formed by the space areas, such as 102 shown in FIG. 1.

Touch points: contact points on a display screen generated by inputting devices, such as user's fingers.

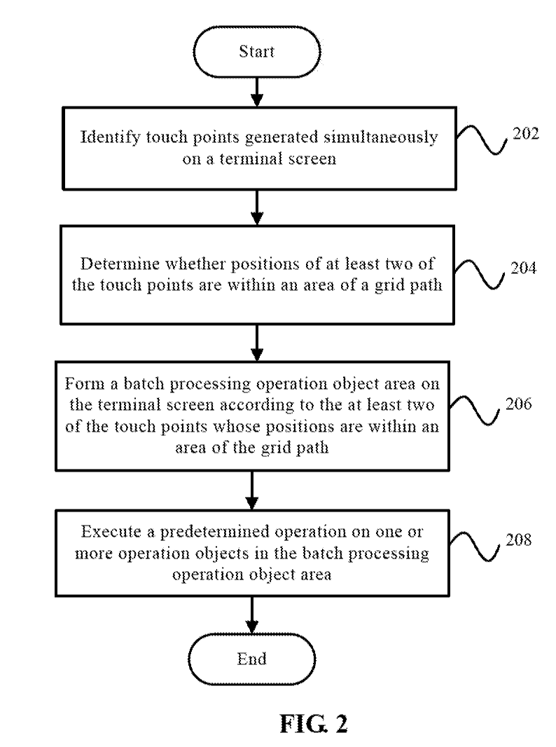

FIG. 2 is a schematic flowchart of one embodiment of a batch processing operation method.

Referring to FIG. 2, according to the present embodiment, the batch processing operation method includes the following steps:

Step 202, identifying simultaneous touch points generated on a terminal screen; step 204, determining whether positions of at least two of the touch points are within an area of a grid path, the grid path being formed by spaces among operation objects on the terminal screen; step 206, forming a batch processing operation object area on the terminal screen according to the at least two of the touch points which have positions within an area of the grid path; and step 208, executing a predetermined operation on one or more of the operation objects in the batch processing operation object area.

Data files, such as application icons, documents, pictures, and so on, can be displayed on the terminal screen. When a size of the terminal screen becomes larger, spaces among the data become larger correspondingly. The background areas outside the data files can form an area of a grid path. Taking advantage of the area of the grid path, the present embodiment checks whether at least two of the touch points are within the area of the grid path. When at least two of the touch points are within the area of the grid path, a batch processing operation mode provided in the present embodiment can be triggered. According to positions of the touch points that are eligible, a batch processing operation object area can be formed on a current interface of the terminal screen. The batch processing operation object area involves a plurality of operation objects. When a user selects an operation, such as a deletion operation, all the operation object involved in the batch processing operation object area are deleted. There is no need to select operation objects one by one, and also no need to enter a particular batch processing operation interface. Efficiency can be improved, and the spaces among the operation objects can be fully utilized. A quick and convenient usage is provided to the spaces.

In the above embodiment, preferably, forming a batch processing operation object area on the terminal screen according to the at least two of the touch points which have positions within an area of the grid path includes: taking the touch points which are within the area of the grid path as vertexes of the batch processing operation object area; generating lines with the touch points as starting points along the grid path; and forming a closed area by intersecting the generated lines, wherein the closed area is the batch processing operation object area.

When forming the batch processing operation object area, the grid path needs to be considered. The touch points are taken as vertexes of the batch processing operation object area, and an area formed by lines which start from the touch points and along the grid path is taken as the batch processing operation object area. In a preferable embodiment, two of the touch points which are located on different positions of the area of the grid path can generate a rectangular area, which is determined to be the batch processing operation object area.

Any of the above embodiments, preferably, includes: generating an entirety of the operation objects by superposing the operation objects in the batch processing operation object areas, after forming the batch processing operation object area, for a single operation by a user.

For further facilitating the operations for a user, when a batch processing operation object area is formed and selected, the operation objects in the batch processing operation object can be superposed to generate an entirety of the operation objects. The user can execute operations on the entirety of the operation objects, such as moving. Thus, there is no need to select the operation objects again.

Any of the above embodiments, preferably, includes: displaying at least one operation option after moving the entirety of the operation objects to a designated area of the terminal screen; and executing a batch processing operation corresponding to one operation option on the entirety of the operation objects when the entirety of the operation objects is moved to the operation option.

When the entirety of the operation objects is moved to a designated area, such as an edge area of the terminal screen, at least one operation option is displayed on the edge area. The at least one operation option can be deletion, hiding, creating a new folder, encryption, or other operations. When the entirety of the operation objects is moved to one operation option, and stays for 2 seconds, it is determined that that particular operation option is selected, and a batch processing operation corresponding to the selected operation option is executed on the entirety of the operation objects. The batch processing operation to the entirety of the operation objects is quick and convenient. The batch processing operation can be achieved without repeated operations by a user.

Any of the above embodiments, preferably, includes: prompting at least one operation option after generating the entirety of the operation objects; and executing a batch processing operation corresponding to a selected operation option on the entirety of the operation objects.

Besides moving the entirety of entirety of the operation objects to a designated area, another embodiment can display the operation options when the entirety of the operation objects is generated. The user can select one operation option. After the operation option is selected, a batch processing operation corresponding to the selected operation option can be executed on the entirety of the operation objects.

Any of the above embodiments, preferably, includes: determining whether a trigger means applied to the touch points matches a predetermined trigger means; executing a batch processing operation mode when the trigger means applied to the touch points matches the predetermined trigger means, and marking the batch processing operation object area and the touch points.

Due to there are too many operation gestures to terminals, for distinguishing between a multitude of possible operation gestures, a particular trigger means of the touch points can be predetermined. The predetermined trigger means enables the terminals to execute the batch processing operation mode. The predetermined trigger means can include a plurality of touch points being long pressed on the terminal screen, or two touch points being pinched to zoom in on the terminal screen, or one of two touch points being fixed and the other one of the two points sliding toward the fixed touch point. After executing the batch processing operation mode, the batch processing operation object area and the touch points can be marked using a particular showing style, for the user to distinguish the batch processing operation object area. The particular showing style can be floating display of the batch processing operation object area, in which the touch points are represented by dots.

Any of the above embodiments, preferably, includes: executing the predetermined operation, upon the condition that an area adjusting operation is not detected in a predetermined time period after marking the batch processing operation object area and the touch points; and generating a new batch processing operation object area according to an adjusted position of one or more of the touch points, upon the condition that an area adjusting operation is detected in the predetermined time period.

It may be understood that, the batch processing operation object area may be formed improperly. The present embodiment can adjust the batch processing operation object area flexibly. A predetermined time period, such as 3 seconds can be set. During the predetermined time period, it is detected whether a user executes an area adjusting operation. When the user executes an area adjusting operation, the batch processing operation object area is adjusted. Otherwise, when the user does not execute the area adjusting operation, the batch processing operation object area is not adjusted.

Assuming that the batch processing operation object area is formed according to two touch points, a position of one of the two touch points can be adjusted to stretch or shrink the batch processing operation object area, when adjusting the batch processing operation object area.

In any of the above embodiments, preferably, when the operation objects are application icons, the predetermined operations include at least one of the following: deleting the application icons, hiding the application icons, uninstalling the application icons, encrypting the application icons or applications corresponding the application icons, backing up data of the applications, moving the application icons into a designated folder, classifying the application icons, and moving the application icons into different folders automatically according to classifications.

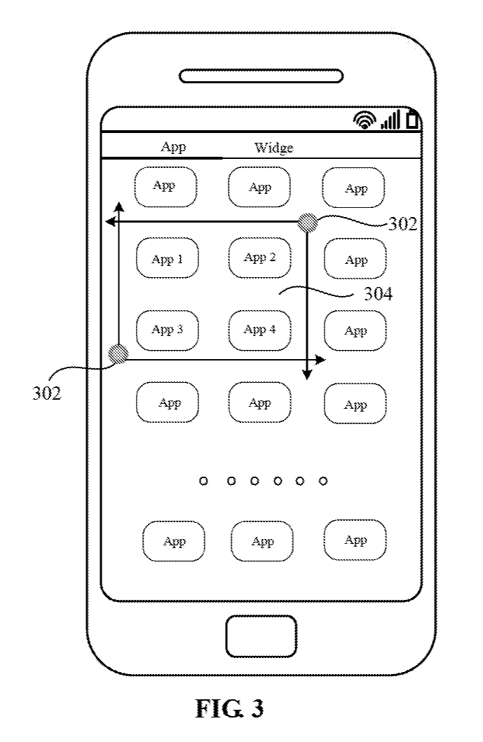

The present disclosure is further depicted below referring to FIG. 3 to FIG. 7.

Referring to FIG. 3, application icons are distributed on a display interface of a mobile terminal. The application icons are arranged by a grid, and background spaces between the application icons form a grid path.

Simultaneous touch points generated on a terminal screen are detected. As shown in FIG. 3, there are two touch points 302, and both the two touch points 302 are in an area of the grid path. Thus, a batch processing operation mode in the present disclosure can be triggered. For distinguishing with existed operation gestures, a particular trigger means can be set. For example, holding down the touch points for a period can be a valid trigger means applied to the batch processing operation mode. Furthermore, when at least two of the touch points are within the area of the grid path, it is confirmed that the batch processing operation mode is executed.

It may be understood that, when there are three touch points generated simultaneously on the terminal screen, however, only one of the three touch points is within the area of the grid path, it is determined that the three touch points are invalid. In other embodiments, when there are three touch points generated simultaneously on the terminal screen, and two of the three touch points are within the area of the grid path, it is determined that the two of the three touch points are valid, and the left one of the three touch points can be without consideration.

The batch processing operation object area can be determined according to positions of the two touch points 302. Lines are generated by starting from the two touch points 302 and along the orientations of the grid path. A closed area 304 formed by intersecting the lines is taken as the batch processing operation object area. As shown in the example of FIG. 3, the closed area 304 involves four application icons. Then, a batch processing operation can be executed on the four application icons.

When there are three or more touch points within the area of the grid path, a plurality of batch processing operation object areas can be formed. The plurality of batch processing operation object areas can be marked with different backgrounds or dotted boxes. Users can select one batch processing operation object area from the plurality of batch processing operation object areas.

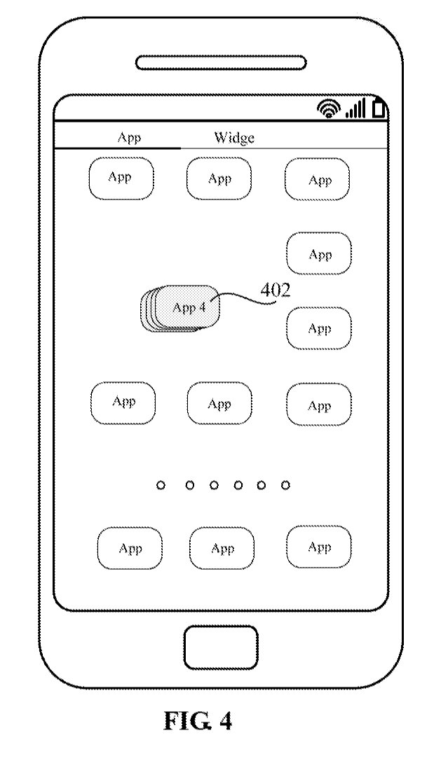

Referring to FIG. 4, when the batch processing operation object area is determined, application icons in the batch processing operation object area are superposed to generate an entirety of the operation objects 402, for executing batch processing operations on the application icons in the batch processing operation object area conveniently. It may be understood that, in other embodiments, there is no need to generate the entirety of the operation objects.

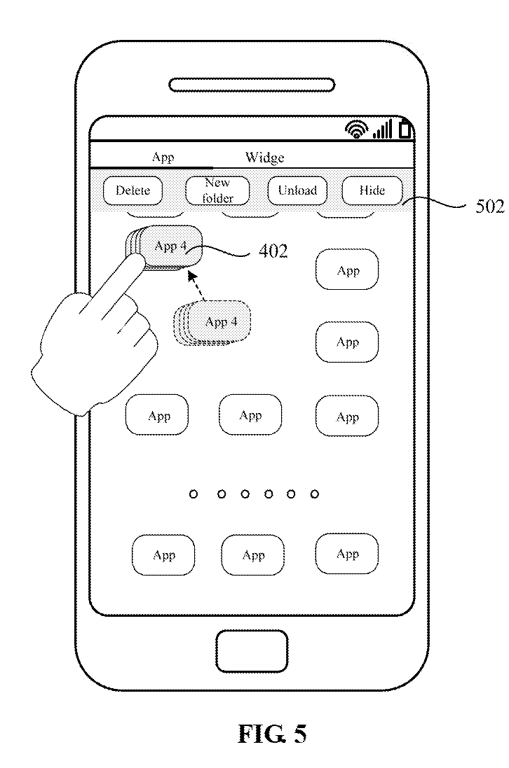

Referring to FIG. 5, after generating the entirety of the operation objects 402, the entirety of the operation objects 402 can be moved. When moving the entirety of the operation objects 402 to a predetermined position on a terminal screen, the operation options 502 can be displayed. In the present embodiment, when the entirety of the operation objects 402 moves to an edge of the terminal screen, the operation options 502 are displayed. The entirety of the operation objects 402 can be moved to one of the operation options, and stays for 2 seconds. Then, it is determined that the operation option is selected. Thus, a batch processing operation corresponding to the selected operation option can be executed to the entirety of the operation objects 402. For example, when the entirety of the operation objects 402 is moved to a deletion option, the application icons in the batch processing operation object area are deleted immediately.

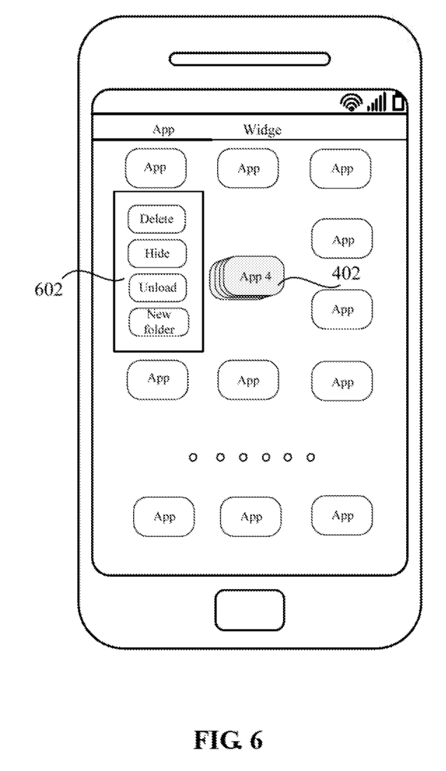

Besides prompting the operation options as mentioned above, the operation options can be prompted using other ways. Referring to FIG. 6, after generating the entirety of the operation objects 402, or after forming the batch processing operation object area, a prompt box 602 can pop up. The prompt box 602 lists a plurality of operation options, including, for example, a deletion operation, a hiding operation, an uninstalling operation, a new folder creating operation, and so on. Thus, there is no need to move the entirety of the operation objects. When a selection of one of the operation options in the prompt box 602 is made, a batch processing operation corresponding to the selected operation option is executed on the application icons in the batch processing operation object area.

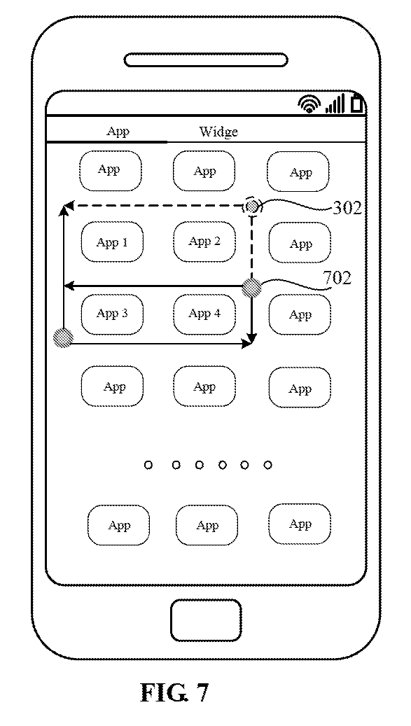

Referring to FIG. 7, sometimes, the batch processing operation object area may be formed improperly. For example, the batch processing operation object area involves one or more improper operation objects. One embodiment in the present disclosure can adjust the batch processing operation object area.

After executing the batch processing operation mode, the batch processing operation object area and the touch points can be marked, for the user to distinguish the batch processing operation object area. When adjusting the batch processing operation object area, a position of any one of the touch points can be moved to form a new batch processing operation object area. Adjustment to the batch processing operation object area needs to be executed within a predetermine time period (for example, 3 seconds) from forming the batch processing operation object area. When no adjustment is executed during the predetermine time period, the batch processing operation object area originally formed is used.

The batch processing operation object area can be formed quickly according to a plurality of touch points, thus, a pinch gesture can be used to execute the batch processing operations. This method is easy and controllable.

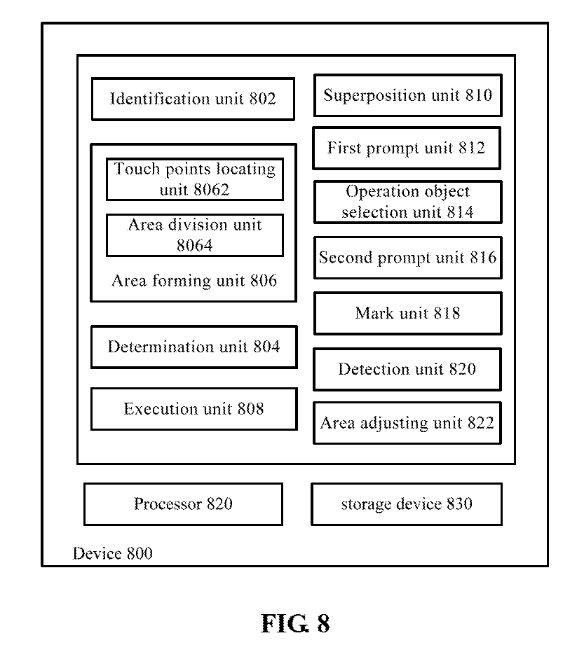

FIG. 8 is a schematic block structure of one embodiment of a batch processing operation device.

Referring to FIG. 8, according to the present disclosure, the batch processing operation device 800 includes: an identification unit 802, which identifies simultaneous touch points generated on a terminal screen; a determination unit 804, which determines whether positions of at least two of the touch points are within an area of a grid path, the grid path being formed by spaces among operation objects on the terminal screen; an area forming unit 806, which connects to the determination unit 804, and forms a batch processing operation object area on the terminal screen according to the at least two of the touch points, when the determination unit 804 determines that the positions of the at least two of the touch points are within an area of a grid path; and an execution unit 808, which connects to the area forming unit 806, and executes a predetermined operation on one or more of the operation objects in the batch processing operation object area.

The word “unit” as used hereinafter, refers to logic embodied in hardware or firmware, or to a collection of software instructions, written in a programming language, such as, for example, Java, C, or assembly. One or more software instructions in the function units may be embedded in firmware. It will be appreciated that the function units may include connected logic units, such as gates and flip-flops, and may include programmable units, such as programmable gate arrays or processors. The function units described herein may be implemented as either software and/or hardware units and may be stored in a storage device. The function units, when controlled by a processor, can execute the functions as mentioned above or as follows.

The batch processing operation device 800 may be a mobile phone, a tablet computer, a personal digital assistant, a notebook computer, or other computing device. The batch processing operation device 800 further includes at least one processor 820 and a storage device 830, which are not shown in FIG. 8. FIG. 8 illustrates only one example of the batch processing operation device 800 that may include more or fewer components than illustrated, or have a different configuration of the various components.

The at least one processor is used to execute the identification unit 802, the determination unit 804, the area forming unit 806, the execution unit 808, and other units or subunits as described below which include computerized instructions in the form of one or more computer-readable programs in the batch processing operation device 800 and execute other applications, such as an operating system, installed in the batch processing operation device 800. The storage devices store the computerized instructions of the identification unit 802, the determination unit 804, the area forming unit 806, the execution unit 808, and other units or subunits as described below, and one or more programs, such as the operating system and applications of the batch processing operation device 800. The storage device can be any type of non-transitory computer-readable storage medium or other computer storage device, such as a hard disk drive, a compact disc, a digital video disc, a tape drive, a storage card (e.g., a memory stick, a smart media card, a compact flash card), or other suitable storage medium, for example.

Data files, such as application icons, documents, pictures, and so on, can be displayed on the terminal screen. When a size of the terminal screen becomes larger, spaces among the data become larger correspondingly. The background areas outside the data files can form an area of a grid path. Taking advantage of the area of the grid path, the present embodiment checks whether at least two of the touch points are within the area of the grid path. When at least two of the touch points are within the area of the grid path, a batch processing operation mode provided in the present embodiment can be triggered. According to positions of the touch points that are eligible, a batch processing operation object area can be formed on a current interface of the terminal screen. The batch processing operation object area involves a plurality of operation objects. When a user selects an operation, such as a deletion operation, all the operation object involved in the batch processing operation object area are deleted. There is no need to select operation objects one by one, and also no need to enter a particular batch processing operation interface. Efficiency can be improved, and the spaces among the operation objects can be fully utilized. A quick and convenient usage is provided to the spaces.

In the above embodiment, preferably, the area forming unit 806 includes: a touch points locating unit 8062, which takes the touch points which are within the area of the grid path as vertexes of the batch processing operation object area, and generates lines with the touch points as starting points along the grid path; and an area division unit 8064, which forms a closed area by intersecting the generated lines, wherein the closed area is the batch processing operation object area.

When forming the batch processing operation object area, the grid path needs to be considered. The touch points are taken as vertexes of the batch processing operation object area, and an area formed by lines which start from the touch points and along the grid path is taken as the batch processing operation object area. In a preferable embodiment, two of the touch points which are located on different positions of the area of the grid path can generate a rectangular area, which is determined to be the batch processing operation object area.

Any of the above embodiments, preferably, includes: a superposition unit 810, which generate an entirety of the operation objects by superposing the operation objects in the batch processing operation object areas, after forming the batch processing operation object area, for a single operation by a user.

For further facilitating the operations for a user, when a batch processing operation object area is formed and selected, the operation objects in the batch processing operation object can be superposed to generate an entirety of the operation objects. The user can execute operations on the entirety of the operation objects, such as moving. Thus, there is no need to select the operation objects again.

Any of the above embodiments, preferably, includes: a first prompt unit 812, which displays at least one operation option after moving the entirety of the operation objects to a designated area of the terminal screen; and an operation object selection unit 814, which executes a batch processing operation corresponding to one operation option on the entirety of the operation objects when the entirety of the operation objects is moved to the operation option.

When the entirety of the operation objects is moved to a designated area, such as an edge area of the terminal screen, at least one operation option is displayed on the edge area. The at least one operation option can be deletion, hiding, creating a new folder, encryption, or other operations. When the entirety of the operation objects is moved to one operation option, and stays for 2 seconds, it is determined that that particular operation option is selected, and a batch processing operation corresponding to the selected operation option is executed on the entirety of the operation objects. The batch processing operation to the entirety of the operation objects is quick and convenient. The batch processing operation can be achieved without repeated operations by a user.

Any of the above embodiments, preferably, includes: a second prompt unit 816, which prompts at least one operation option after generating the entirety of the operation objects; and executes a batch processing operation corresponding to a selected operation option on the entirety of the operation objects.

Besides moving the entirety of entirety of the operation objects to a designated area, another embodiment can display the operation options when the entirety of the operation objects is generated. The user can select one operation option. After the operation option is selected, a batch processing operation corresponding to the selected operation option can be executed on the entirety of the operation objects.

Any of the above embodiments, preferably, the determination unit 804 further determines whether a trigger means applied to the touch points matches a predetermined trigger means; and the batch processing operation device further includes: a mark unit 818, which executes a batch processing operation mode when the trigger means applied to the touch points matches the predetermined trigger means, and marks the batch processing operation object area and the touch points.

Due to there are too many operation gestures to terminals, for distinguishing between a multitude of possible operation gestures, a particular trigger means of the touch points can be predetermined. The predetermined trigger means enables the terminals to execute the batch processing operation mode. The predetermined trigger means can include a plurality of touch points being long pressed on the terminal screen, or two touch points being pinched to zoom on the terminal screen, or one of two touch points being fixed and the other one of the two points sliding toward the fixed touch point. After executing the batch processing operation mode, the batch processing operation object area and the touch points can be marked using a particular showing style, for the user to distinguish the batch processing operation object area. The particular showing style can be floating display of the batch processing operation object area, in which the touch points are represented by dots.

Any of the above embodiments, preferably, includes: a detection unit 820, which executes the predetermined operation, upon the condition that an area adjusting operation is not detected in a predetermined time period after marking the batch processing operation object area and the touch points; and an area adjusting unit 822, which generates a new batch processing operation object area according to an adjusted position of one or more of the touch points, upon the condition that an area adjusting operation is detected in the predetermined time period.

It may be understood that, the batch processing operation object area may be formed improperly. The present embodiment can adjust the batch processing operation object area flexibly. A predetermined time period, such as 3 seconds can be set. During the predetermined time period, it is detected whether a user executes an area adjusting operation. When the user executes an area adjusting operation, the batch processing operation object area is adjusted. Otherwise, when the user does not execute the area adjusting operation, the batch processing operation object area is not adjusted.

Assuming that the batch processing operation object area is formed according to two touch points, a position of one of the two touch points can be adjusted to stretch or shrink the batch processing operation object area, when adjusting the batch processing operation object area.

In any of the above embodiments, preferably, when the operation objects are application icons, the predetermined operations include at least one of the following: deleting the application icons, hiding the application icons, uninstalling the application icons, encrypting the application icons or applications corresponding the application icons, backing up data of the applications, moving the application icons into a designated folder, classifying the application icons, and moving the application icons into different folders automatically according to classifications.

According to another aspect of the present disclosure, a program product stored in a non-transitory computer readable medium is provided. The program product is used to execute batch processing operation, and includes instructions executable by a computer system to perform the following steps: identifying simultaneous touch points on a terminal screen; determining whether positions of at least two of the touch points are within an area of a grid path, the grid path being formed by spaces among operation objects on the terminal screen; forming a batch processing operation object area on the terminal screen according to the at least two of the touch points which have positions within an area of the grid path; and executing a predetermined operation on one or more of the operation objects in the batch processing operation object area.

According to another aspect of the present disclosure, a non-transitory computer readable medium is also provided. The non-transitory computer readable medium stores a program product which is used to execute batch processing operation and includes instructions executable by a computer system to perform the following steps: identifying simultaneous touch points on a terminal screen; determining whether positions of at least two of the touch points are within an area of a grid path, the grid path being formed by spaces among operation objects on the terminal screen; forming a batch processing operation object area on the terminal screen according to the at least two of the touch points which have positions within an area of the grid path; and executing a predetermined operation on one or more of the operation objects in the batch processing operation object area.

According to another aspect of the present disclosure, a program readable by a machine is also provided. When executed by the machine, the program can cause the machine to perform a batch processing operation method of any of the above mentioned embodiments.

According to another aspect of the present disclosure, a storage medium which stores a program readable by a machine is also provided. When executing the program, the machine can perform a batch processing operation method of any of the above mentioned embodiments.

The above embodiments and drawings are set forth in order to provide a thorough understanding of the present disclosure. According to the embodiments above, the present disclosure can utilize the space areas among the application icons, and locates a batch processing operation object area quickly according to a user′ gesture and positions of touch points. The present disclosure can execute batch processing operations to application icons, but does not need to enter into a particular interface to check the application icons one by one. It is convenient and quick using the present disclosure. Furthermore, user experience is improved, further intelligence and operability of mobile terminal is also improved using the present disclosure.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented batch processing operation method, comprising:
identifying simultaneous touch points on a terminal screen;
determining whether positions of at least two of the touch points are within an area of a grid path, the grid path being formed by spaces among operation objects on the terminal screen;
forming a batch processing operation object area on the terminal screen according to the at least two of the touch points which have positions within an area of the grid path; and
executing a predetermined operation on one or more of the operation objects in the batch processing operation object area.

2. The method of claim 1, wherein forming a batch processing operation object area on the terminal screen according to the at least two of the touch points which have positions within an area of the grid path, comprises:
taking the touch points which are within the area of the grid path as vertexes of the batch processing operation object area;
generating lines with the touch points as starting points along the grid path; and
forming a closed area by intersecting the generated lines, wherein the closed area is the batch processing operation object area.

3. The method of claim 1, further comprising:
generating an entirety of the operation objects by superposing the operation objects in the batch processing operation object areas, after forming the batch processing operation object area, for a single operation by a user.

4. The method of claim 3, further comprising:
displaying at least one operation option after moving the entirety of the operation objects to a designated area of the terminal screen; and
executing a batch processing operation corresponding to one operation option on the entirety of the operation objects when the entirety of the operation objects is moved to the operation option.

5. The method of claim 1, further comprising:
determining whether a trigger means applied to the touch points matches a predetermined trigger means; and
executing a batch processing operation mode when the trigger means applied to the touch points matches the predetermined trigger means, and marking the batch processing operation object area and the touch points.

6. The method of claim 5, further comprising:
executing the predetermined operation, upon the condition that an area adjusting operation is not detected in a predetermined time period after marking the batch processing operation object area and the touch points; and
generating a new batch processing operation object area according to an adjusted position of one or more of the touch points, upon the condition that an area adjusting operation is detected in the predetermined time period.

7. A batch processing operation device, comprising:
at least one processor; and
a storage device storing a plurality of instructions, which when executed by the processor, causes the at least one processor to:
identify simultaneous touch points generated on a terminal screen;
determine whether positions of at least two of the touch points are within an area of a grid path, the grid path being formed by spaces among operation objects on the terminal screen;
form a batch processing operation object area on the terminal screen according to the at least two of the touch points which have positions within an area of the grid path; and
execute a predetermined operation on one or more of the operation objects in the batch processing operation object area.

8. The device of claim 7, wherein the storage device further stores instructions when executed by the processor, causes the at least one processor to:
take the touch points which are within the area of the grid path as vertexes of the batch processing operation object area;
generate lines with the touch points as starting points along the grid path; and
form a closed area by intersecting the generated lines, wherein the closed area is the batch processing operation object area.

9. The device of claim 7, wherein the storage device further stores instructions when executed by the processor, causes the at least one processor to:
generate an entirety of the operation objects by superposing the operation objects in the batch processing operation object areas, after forming the batch processing operation object area, for a single operation by a user.

10. The device of claim 9, wherein the storage device further stores instructions when executed by the processor, causes the at least one processor to:
display at least one operation option after moving the entirety of the operation objects to a designated area of the terminal screen; and
execute a batch processing operation corresponding to one operation option on the entirety of the operation objects when the entirety of the operation objects is moved to the operation option.

11. The device of claim 7, wherein the storage device further stores instructions when executed by the processor, causes the at least one processor to:
determine whether a trigger means applied to the touch points matches a predetermined trigger means; and
execute a batch processing operation mode when the trigger means applied to the touch points matches the predetermined trigger means, and mark the batch processing operation object area and the touch points.

12. The device of claim 11, wherein the storage device further stores instructions when executed by the processor, causes the at least one processor to:
execute the predetermined operation, upon the condition that an area adjusting operation is not detected in a predetermined time period after marking the batch processing operation object area and the touch points; and
generate a new batch processing operation object area according to an adjusted position of one or more of the touch points, upon the condition that an area adjusting operation is detected in the predetermined time period.

13. A non-transitory storage medium having stored thereon instructions that, when executed by a processor of a device, causes the device to perform a method for allocating network data channels to the device, the method comprising:
identifying simultaneous touch points on a terminal screen;
determining whether positions of at least two of the touch points are within an area of a grid path, the grid path being formed by spaces among operation objects on the terminal screen;
forming a batch processing operation object area on the terminal screen according to the at least two of the touch points which have positions within an area of the grid path; and
executing a predetermined operation on one or more of the operation objects in the batch processing operation object area.

14. The non-transitory storage medium according to claim 13, wherein forming a batch processing operation object area on the terminal screen according to the at least two of the touch points which have positions within an area of the grid path, comprises:
taking the touch points which are within the area of the grid path as vertexes of the batch processing operation object area;
generating lines with the touch points as starting points along the grid path; and
forming a closed area by intersecting the generated lines, wherein the closed area is the batch processing operation object area.

15. The non-transitory storage medium according to claim 13, wherein the method further comprises:
generating an entirety of the operation objects by superposing the operation objects in the batch processing operation object areas, after forming the batch processing operation object area, for a single operation by a user.

16. The non-transitory storage medium according to claim 15, wherein the method further comprises:
displaying at least one operation option after moving the entirety of the operation objects to a designated area of the terminal screen; and
executing a batch processing operation corresponding to one operation option on the entirety of the operation objects when the entirety of the operation objects is moved to the operation option.

17. The non-transitory storage medium according to claim 13, wherein the method further comprises:
determining whether a trigger means applied to the touch points matches a predetermined trigger means; and
executing a batch processing operation mode when the trigger means applied to the touch points matches the predetermined trigger means, and marking the batch processing operation object area and the touch points.

18. The non-transitory storage medium according to claim 17, wherein the method further comprises:
executing the predetermined operation, upon the condition that an area adjusting operation is not detected in a predetermined time period after marking the batch processing operation object area and the touch points; and
generating a new batch processing operation object area according to an adjusted position of one or more of the touch points, upon the condition that an area adjusting operation is detected in the predetermined time period.
